(19) United States
(12) Patent Application Publication
(10) Pub. No.: US 2026/0186840 A1
(43) Pub. Date: Jul. 2, 2026

(54) RESOURCE USAGE TRANSITION HINTS

(71) Applicant: Arm Limited, Cambridge (GB)

(72) Inventors: Angus William James Logan, Cambridge (GB); Dominic William Brown, Cambridge (GB); Christopher Vincent Severino, Cambridge (GB)

(73) Assignee: Arm Limited, Cambridge (GB)

(21) Appl. No.: 19/131,707

(22) PCT Filed: Oct. 25, 2023
(86) PCT No.: PCT/GB2023/052795

§ 371 Date: May 21, 2025

(30) Foreign Application Priority Data
Nov. 25, 2022 (GB) 2217688.7

(51) Int. Cl. G06F 9/50

(52) U.S. Cl. CPC G06F 9/5027; G06F 9/5094

(57) ABSTRACT

There is provided a control apparatus in which assertion circuitry asserts a request for usage devices to change their usage of a resource from an original usage. Receive circuitry receives a response to the request from the usage devices and hint circuitry asserts a hint to those of the plurality of usage devices for which the response has not been received, that a refusal in response to the request is preferred over an acceptance. There is also provided a usage device in which receive circuitry receives a request from a control apparatus to change the usage device's usage of a resource from an original usage, and receives a hint from the control apparatus that a refusal in response to the request is optional and preferred. Determination circuitry makes a determination of whether the request is to be met based on at least one of: the request and the hint and response circuitry provides a response to the request based on the determination.

The present technique relates to resource control in, for instance, a data processing apparatus.

Resource usage between usage devices in (for instance) a data processing apparatus may be coordinated by a central controller.

In systems such as data processing systems, a controller may be responsible for coordinating the resource usage of other usage devices in the system. Such a controller might send out a request for a group of the usage devices to change their resource usage (e.g. to decrease their power consumption). These processes can, however, have significant overhead. If new information comes to light at the controller, it is often necessary for all of the usage devices to complete their change in resource usage and then for the change to be ‘undone’. This back-and-forth can be particularly inefficient.

Viewed from a first example configuration, there is provided a control apparatus comprising: assertion circuitry configured to assert a request for a plurality of usage devices to change their usage of a resource from an original usage; receive circuitry configured to receive a response to the request from the plurality of usage devices; and hint circuitry configured to assert a hint to those of the plurality of usage devices for which the response has not been received, that a refusal in response to the request is preferred over an acceptance.

Viewed from a second example configuration, there is provided a method comprising: asserting a request for a plurality of usage devices to change their usage of a resource from an original usage; and asserting a hint to those of the plurality of usage devices for which a response to the request has not been received, that a refusal in response to the request is preferred over an acceptance.

Viewed from a third example configuration, there is provided a usage device comprising: receive circuitry configured to receive, from a control apparatus, a request to change the usage device's usage of a resource from an original usage, and to receive, from the control apparatus, a hint that a refusal in response to the request is optional and preferred; determination circuitry configured to make a determination of whether the request is to be met based on at least one of: the request and the hint; and response circuitry configured to provide a response to the request based on the determination.

Viewed from a fourth example configuration, there is provided a method comprising: receiving a request from a control apparatus to change the usage device's usage of a resource from an original usage; receiving a hint from the control apparatus that a refusal in response to the request is optional and preferred; making a determination of whether the request is to be met based on at least one of: the request and the hint; and providing a response to the request based on the determination.

The present technique will be described further, by way of example only, with reference to embodiments thereof as illustrated in the accompanying drawings, in which:

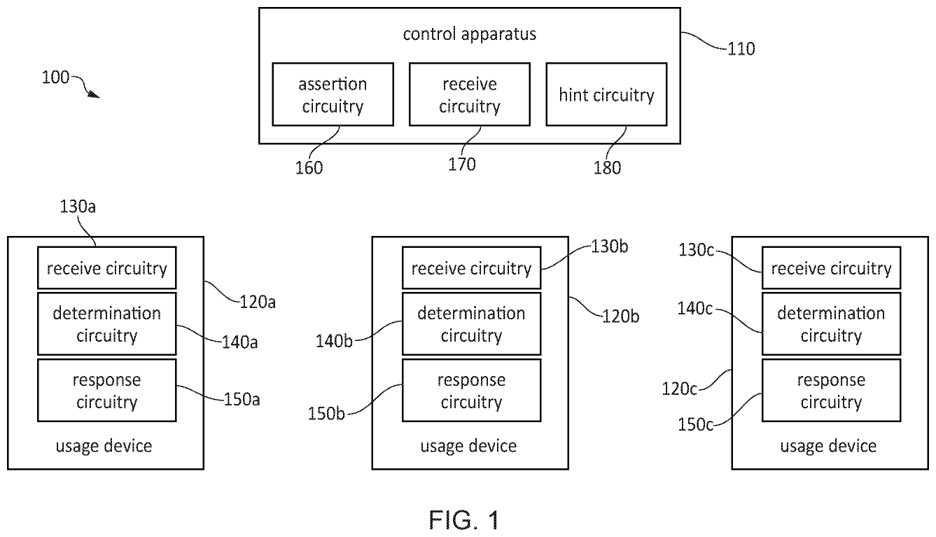

FIG. 1 illustrates a system containing a control apparatus and a plurality of usage devices;

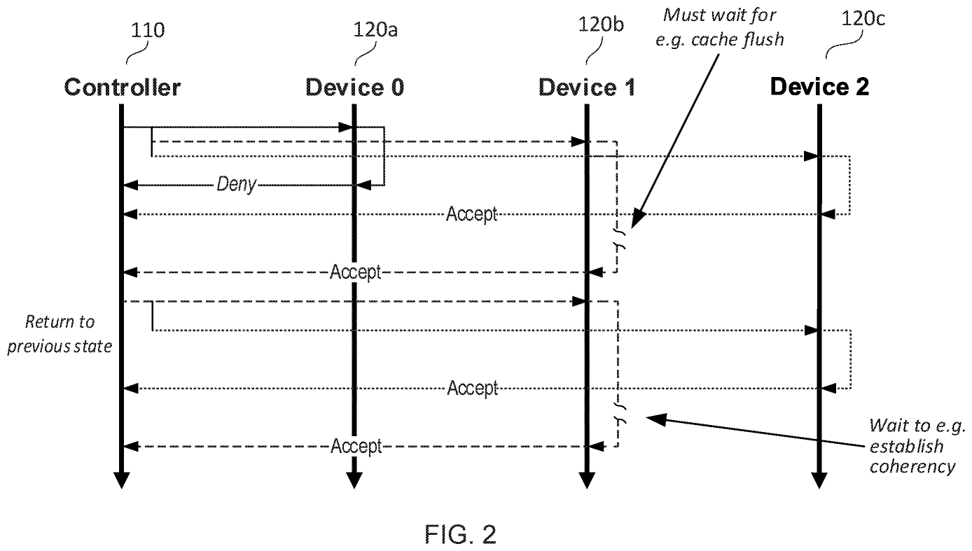

FIG. 2 shows an example of the process without the hint being provided;

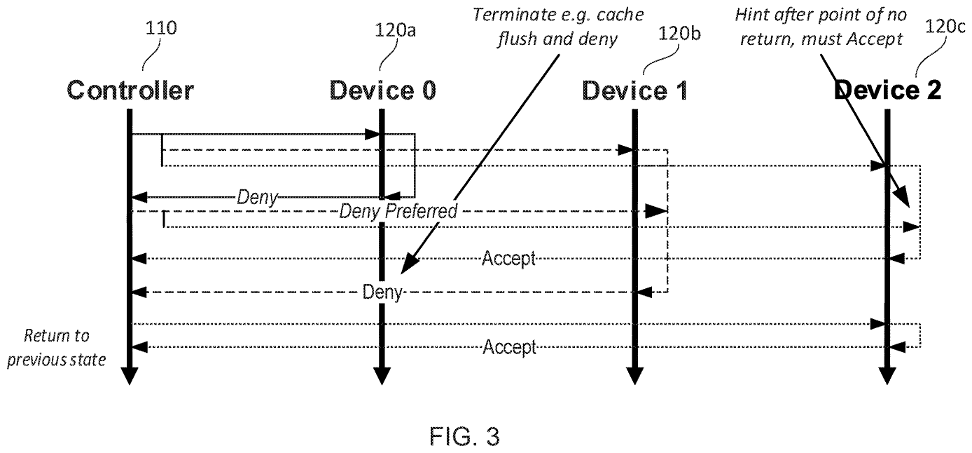

FIG. 3 illustrates the same process with the hint being used;

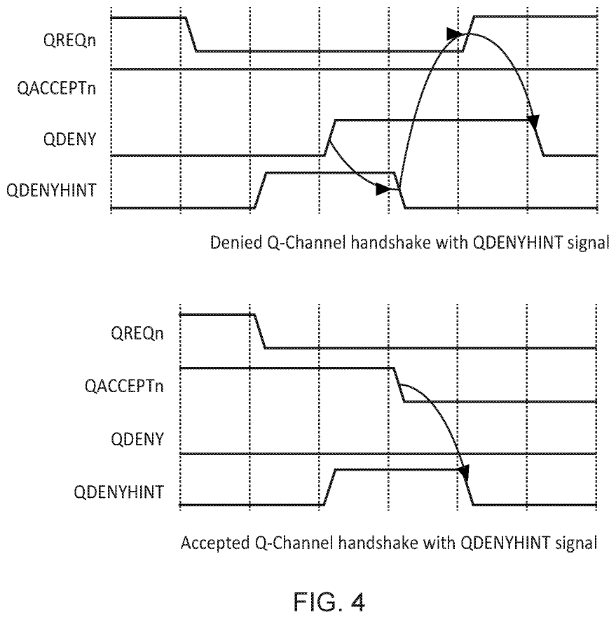

FIG. 4 illustrates how the process can be implemented using Q-Channels;

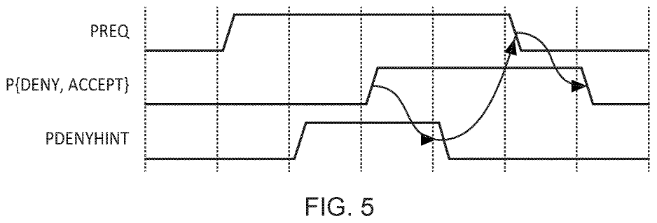

FIG. 5 illustrates how the process can be implemented using P-Channels;

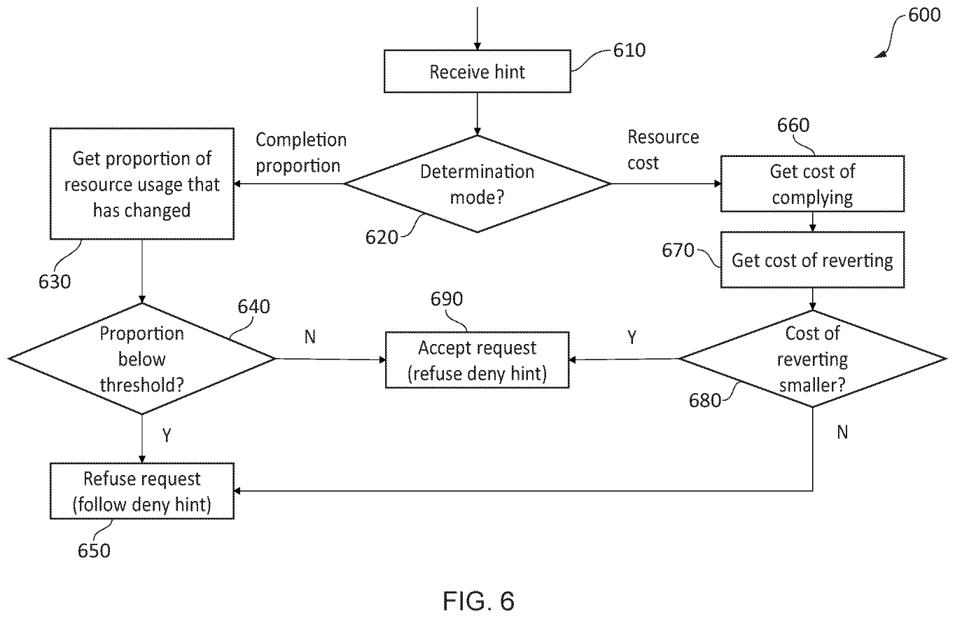

FIG. 6 shows a flowchart that illustrates an example of the decision making process for determining whether a hint should be followed; and

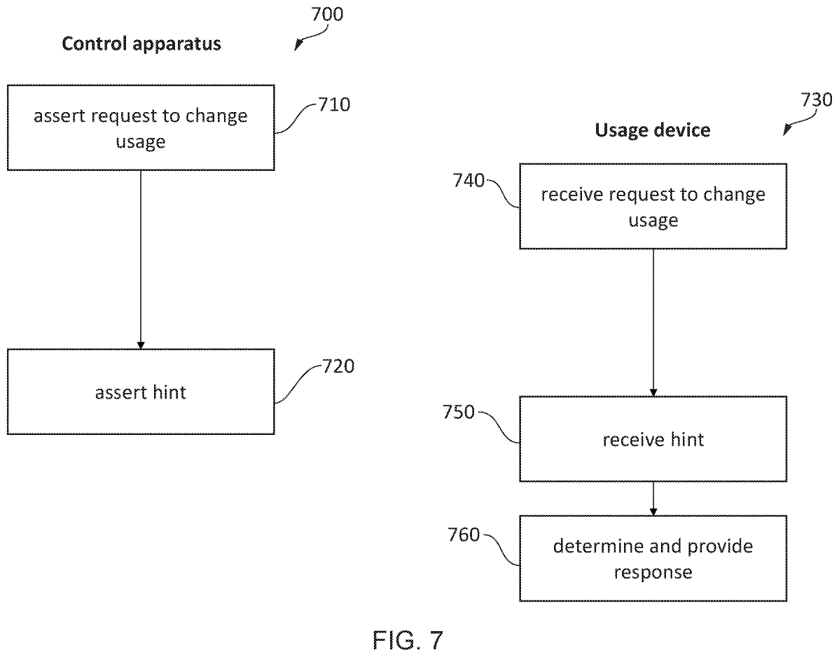

FIG. 7 shows a pair of flow charts that illustrate the processes performed by the control apparatus and the usage devices.

Before discussing the embodiments with reference to the accompanying figures, the following description of embodiments and associated advantages is provided.

In accordance with one example configuration there is provided control apparatus comprising: assertion circuitry configured to assert a request for a plurality of usage devices to change their usage of a resource from an original usage; receive circuitry configured to receive a response to the request from the plurality of usage devices; and hint circuitry configured to assert a hint to those of the plurality of usage devices for which the response has not been received, that a refusal in response to the request is preferred over an acceptance.

The control apparatus may be responsible for regulating the resource usage of the usage devices. In these situations, it is possible that the initial request might have to be changed. For instance, if new information comes to light at the controller that the original request should not be complied with. In such a situation, the usage devices may comply with the request and then the request reversed so that the usage devices resume their previous usage of the resource. This can be inefficient, particularly if the resource usage change process involved a large amount of overhead. In the present examples, this is dealt with by the sending the usage devices a hint to those of the usage devices that have not already replied that they can (and preferably should) refuse the original request. This can save those devices from completing preparations to meet the original request. The hint is not a demand and can be refused (in other words, the original request still complied with). This might happen in a number of situations—for instance, the usage device has already reached a point of no return, then it may not be feasible for the device to then refuse the original request. Those devices that refuse the request to change their resource usage are then able to benefit from not having to respond to a further request to restore their usage to the original usage. Consequently, energy/time can be saved. By collating information at the control apparatus, it is possible to avoid routing the outcome of the request at each device to each other device. This saves area and routing cost/complication.

In some examples, the hint is asserted in response to a refusal from one of the plurality of usage devices. In particular, if one device refuses the group request, then this may not be immediately known to other usage devices, who may start to comply with the request. This can result in the expenditure of other resources, e.g. as preparations are made to change the resource usage. Once the transition is complete, the refusal may then cause the entire group of devices to be required to revert to their previous (the original) usage, requiring another transition and possibly the expenditure of still further resource.

In some examples, the resource is energy. The request can therefore be a request for the usage devices (the devices that use the resource) to change their energy usage. This could be by a fixed amount, a relative amount (e.g. a percentage) or to a particular level.

In some examples, the request is for the plurality of usage devices to change an energy level at which the plurality of usage devices operate. Rather than enabling the free choice of energy (up to a particular limit) a number of distinct and separate energy levels can be defined. The request can therefore either target one of these specific energy levels, or can demand an increase or decrease in the current level. Different energy levels could, for instance, define the way in which particular systems are used. For instance, caches might be powered down in particular energy levels (necessitating the offloading of data from that cache when a transition to those energy levels take place).

In some examples, the request is for the plurality of usage devices to lower their usage of the resource. In other examples, the request could be for the usage devices to increase their usage of the resource.

In some examples, the assertion circuitry is configured, in response to the response being received from each of the plurality of usage devices when the response from one of the usage devices is a refusal, to assert a further request for a second of the plurality of usage devices to return to the original usage. In these examples, if one device sends a refusal, then devices that accepted the resource usage change are made to revert to their original resource usage (e.g. to the point before the request to change the resource usage was made).

In some examples, the request is asserted using P-Channels or Q-Channels. Q-Channels are primarily used in signalling where a binary signalling semantics (e.g. start/stop) are suitable. In contrast, P-Channels can be used for more complex scenarios having multiple transitions. Such mechanisms may be defined as part of a low power interface such as, for instance, the AMBA Low Power Interface Specification developed by Arm® in Cambridge, UK. More details can be found in the low power interface specification https://developer.arm.com/documentation/ihi0068/latest

In accordance with another example, there is provided a usage device comprising: receive circuitry configured to receive, from a control apparatus, a request to change the usage device's usage of a resource from an original usage, and to receive, from the control apparatus, a hint that a refusal in response to the request is optional and preferred; determination circuitry configured to make a determination of whether the request is to be met based on at least one of: the request and the hint; and response circuitry configured to provide a response to the request based on the determination.

In response to receiving the request to change the usage device's usage of a resource from an original usage, the device makes a decision as to whether the request should be followed or not. The request is not mandatory, so that the device can refuse (for instance, if the request is to reduce usage of a resource that is actively required). At some point, the control apparatus signals a hint to the usage device to indicate that its previous request can be refused. The hint is also not mandatory, but is encouraged/preferred. The determination circuitry is provided to determine whether the initial request should be complied with (both before the hint is received and after the hint is received). Based on this determination, a response is issued to the control apparatus.

In some examples, the resource is energy. The request can therefore be a request for the usage devices to change its energy usage. This could be by a fixed amount, a relative amount (e.g. a percentage) or to a particular level.

In some examples, the request is for the usage device to change an energy level at which it operates. Rather than enabling the free choice of energy (up to a particular limit) a number of distinct and separate energy levels can be defined. The request can therefore either target one of these specific energy levels, or can demand an increase or decrease in the current level. Different energy levels could, for instance, define the way in which particular systems are used. For instance, caches might be powered down in particular energy levels (necessitating the offloading of data from that cache when a transition to those energy levels take place).

In some examples, the request is for the usage device to lower its usage of the resource. In other examples, the request could be for the usage device to increase its usage of the resource.

In some examples, the request is asserted using P-Channels or Q-Channels. Q-Channels are used in signalling where a binary signalling semantics (e.g. start/stop) are suitable. In contrast, P-Channels can be used for more complex scenarios having multiple transitions. Such mechanisms may be defined as part of a low power interface such as, for instance, the AMBA Low Power Interface Specification developed by Arm® in Cambridge, UK. More details can be found in the low power interface specification https://developer.arm.com/documentation/ihi0068/latest

In some examples, the determination circuitry is configured to make the determination based on a proportion of the usage device's usage of the resource that has changed between the request and the hint being received by the receive circuitry. These examples may, in effect, consider how complete the process of changing the resource usage is. For example, in some of these embodiments, if the change in energy usage is almost complete, then the process may be allowed to finish. Although this might result in extra work being done for no reason, such an approach might be suitable where reversing the change process part way through would itself be expensive.

In some examples, the determination circuitry is configured to make the determination based on an estimated cost difference between: a cost of complying with the request between the request and the hint being received by the receive circuitry; and a cost of reverting to the original usage after the request has been complied with. A certain amount of overhead is experienced in meeting the requirements of the original request. For instance, the original request might be for a reduction in power level that would result in a cache being disabled—the disabling of a cache might require data to be offloaded from that cache, which would result in a short-term increase in power usage. Hence, in these examples, whether or not the hint is followed is simply a comparison of a cost (e.g. of energy expenditure or another resource) of continuing to comply with the request as opposed to the cost of having to revert to the original resource usage (when the request is complied with and the controller reverses the original request). In some examples, the comparison might also consider the cost savings achieved between completing the original request and a reversion of the original request taking place. Of course, in these examples, if the usage device had already intended to refuse the request, then the issue may be moot.

Particular embodiments will now be described with reference to the figures.

FIG. 1 illustrates a system 100 containing a control apparatus 110 and a plurality of usage devices 120a, 120b, 120c. Here, the control apparatus is responsible for managing usage of a particular resource that is used by the plurality of usage devices 120a, 120b 120c. Subsequent figures will consider the example in which the resource is energy (as defined by a number of energy levels) but other resources such as a clock or even a bridge between different domains being open and closed.

Typically, the assertion circuitry 160 signals to the usage device 120a, 120b, 120c that a change in the resource usage (e.g. energy) is requested. This request is received by receive circuitry 130a, 130b, 130c at each of the usage devices 120a, 120b, 120c. In response to receiving the request, the determination circuitry 140a, 140b, 140c at each usage device 120a, 120b, 120c can decide whether or not the request should be complied with. Once the determination is made, response circuitry 150a, 150b 150c provides the response to the control apparatus 110. In addition, those of the usage devices 120b, 120c that agree to the request will begin the process of changing their resource usage. This transition process can be time consuming and can itself be resource intensive as a consequence of certain actions having to be performed. For instance, a transition to a lower energy usage might result in the deactivation of a cache. The deactivation of a cache will generally require dirty data to be backed up (e.g. written to another cache and/or to main memory). This process can take time, and due to the need to perform a number of memory operations in a short space of time, can result in increased energy usage.

During all of this, it is possible that the decision making process taking place at the control apparatus that instigated the original request will determine that the original request should not, in fact, be complied with. This might occur as a consequence of new information being received by the control apparatus that indicates that it is undesirable (or unnecessary) for the original request to be performed. For instance, the original request might have been to reduce the energy level in order to reduce the overall energy consumption of the system. If after issuing the request, a power up request comes in (e.g. from an interrupt) then it might not be desirable for the original request to be performed.

A problem that occurs when this situation arises is that the multiple requests might end up being issued by the control apparatus 110—one to start a first change, and another to start a second change that is occasioned by the new information becoming available. This can therefore be time and/or resource intensive and can lead to resource wastage. For instance, if the request is to a usage device in the form of a processor core to be powered down then this may result in dirty data being written back to memory. If, however, the control apparatus 110 subsequently determines that the core power down is not necessary, then that transfer of data has taken place unnecessarily. This is clearly undesirable. One situation in which new information might come to light is if, in response to the request, one of the usage devices 120a refuses that request. In this situation, the refusal might prevent the control apparatus' plans from being enacted, thereby eliminating the need for any of the usage devices 120a, 120b, 120c to participate. The original request may therefore be reverted.

The present technique introduces a mechanism for the control apparatus 110 to send a subsequent hint signal to each of the usage devices 120a, 120b, 120c that has not yet answered the request, that a refusal response to the previous request is preferred. This does not mean that a refusal is obligatory—merely that it would be preferable to acceptance.

Whether or not the hint is complied with is determined by the determination circuitry 140a, 140b, 140c on each of the usage devices 120a, 120b, 120c that receive the hint. This may be dependent on the nature of the original request and the extent to which any processing for that request has already been performed. For instance, one of the usage devices 120c may have passed a ‘point of no return’ in complying with the original request, such that it cannot be reversed until the process is completed. In this case, an acceptance might still take place. In other situations, the question may be dependent on how much of the transition has been completed or whether an acceptance (with a possible later reversion) or refusal (having already performed part of the process) would be more efficient overall. This can be determined from knowledge of the resources consumed by the various processes at different stages.

FIG. 2 shows an example of the process without the hint being provided. Here, the controller 110 issues the request to each of the usage devices 120a, 120b, 120c. The request is immediately denied by usage device 0 120a. It is later (due to the increased time taken to communicate) accepted by usage device 2 120c and much later (due to a delay in the transition process from performing a cache flush) by usage device 1 120b. Due to the denial, a return to the previous operating state then takes place (for consistency of state). In this case, the return to the previous state is accepted by usage device 2 120c and usage device 1 120b. A delay is again experienced at usage device 1 120b for the establishment of coherency. The deny state is maintained at the controller until all of the usage devices 120a, 120b, 120c have returned to their original state.

FIG. 3 illustrates the same process with the hint being used. Again, the same request is used from the controller 110 to the three usage devices 120a, 120b, 120c. However, in response to the refusal from usage device 0 120a, a hint is issued to the remaining usage devices 120b, 120c. The hint is a suggestion that a refusal would be preferred (but is not necessarily essential). In this example, the hint is received by usage device 2 120c after the point of no return. That is, so much of the transition process for responding to the original request has been performed at usage device 2 120c that it can only accept the original request (that is, the hint is refused). In contrast, the point of no return has not been reached at usage device 1 120b. Here, the determination is made that the request can be refused. Consequently, the cache flush process is terminated (or not begun) and a refusal is issued. Since denials are received by the controller 110, a return to previous state occurs, but this time only for the usage device 2 120c.

As a consequence of this, resources are saved as a consequence of the cache flush process not being fully performed by usage device 1 120b. Furthermore, no loss of capability is experienced while waiting for the return to previous state to take place at usage device 1 120b. Also, no resources are expended in reversing the change at usage device 1 120b. The return to previous state is still performed for usage device 120c, but this would have happened anyway, even without the hint being issued.

FIG. 4 illustrates how the process can be implemented using Q-Channels. Q-Channel handshaking can be used for components or resources that have on/off semantics. It is a robust signalling process that places particular conditions on how signals can be responded to, and the order in which signals are to be asserted/de-asserted. This helps to avoid race conditions and uncertainty in signal ordering, particularly where multiple clock domains might be in use. Here, a number of signals are used:
QREQn: A request from the controller 110 to one or more usage devices 120a, 120b, 120c to stop (or start) usage of a resource (e.g. to power down and stop using power). When the signal is low, the request is being made. When the signal is high, no request is being made.
QACCEPTn: A response from a usage device 120a as to whether the request received from the controller 110 is accepted or not. When the signal is low, the request is accepted. When it is high, the request has not been accepted (but may not have been refused either).
QDENY: A response from a usage device 120a as to whether the request received from the controller 110 is refused or not. When the signal is high, the request is refused. When it is low, the request has not been refused (but may not have been accepted either).
QDENYHINT: A signal to indicate whether a hint is being made that a refusal of the previously issued request is preferred (but not mandatory).

The restrictions on the assertions/deassertions can be summarised as follows:
QREQn can only transition from low to high when at least the following conditions are met:
   QDENYHINT is low and
   ((QACCEPTn is low and QDENY is high) or (QACCEPTn is low and QDENY is low))
QREQn can only transition from high to low when at least the following conditions are met:
   QDENYHINT is low and
   QACCEPTn is high and
   QDENY is low
QACCEPTn can only transition from low to high when at least the following conditions are met:
   QREQn is high
QACCEPTn can only transition from high to low when at least the following conditions are met:
   QREQn is low and
   QDENY is low
QDENY can only transition from low to high when at least the following conditions are met:
   QREQn is low and
   QACCEPTn is high
QDENY can only transition from high to low when at least the following conditions are met:
   QREQn is high
QDENYHINT can only transition from low to high when at least the following conditions are met:
   QREQn is low and
   QACCEPTn is high and
   QDENY is low
QDENYHINT can only transition from high to low when at least either of the following conditions are met:
   QREQn is low and QDENY is high and QACCEPTn is high
   QREQn is low and QDENY is low and QACCEPTn is low

For instance, once the QREQn signal is lowered, thereby indicating a request to (for instance) stop using power, the request cannot simply be withdrawn by raising the signal again. Instead, the QREQn signal cannot be changed until a response is received from each of the usage devices 120a, 120b, 120c (via either QACCEPTn or QDENY as appropriate).

In these examples, the QREQn signal is lowered, thereby indicating a request for the usage devices 120a, 120b, 120c to stop using the given resource. In each of the two examples in FIG. 4, the QDENYHINT signal is then asserted (raised) indicating that a refusal would be preferred.

In the first example, the QDENY signal is then raised, indicating that the hint has been complied with (i.e. the request was refused) and the power down is not performed. This results in the QDENYHINT signal being deasserted, which results in the QREQn signal being raised, and finally the QDENY signal being lowered—in other words, the signalling process ends.

In the second example, the QACCEPTn signal is lowered, indicating that the hint has not been complied with (i.e. the request was accepted) and the power down is performed. This results in the Q-Channel moving into the stopped state (all signals low, simple isolation rules) and the handshake is complete and stable. When the controller wants to return to the run state, QREQn will go high. QREQn cannot return to high again until QDENYHINT has gone low (in order to ensure the ordering of requests).

FIG. 5 illustrates how the process can be implemented using P-Channels. P-Channel handshaking can be used for components or resources where the semantics are more complicated than merely on/off. It therefore enables finer-grained control. For instance, P-Channels might be used to express a particular level to which resource usage should change. Like Q-Channels, the P-Channel signalling process is robust and is used to avoid race conditions. The P-Channel handshake is said to be in progress when any of PREQ, PACCEPT or PDENY are high and the next request cannot start again until they all return to a low state. The following signals are used:
PREQ: A request from the controller 110 to one or more usage devices 120a, 120b, 120c to change usage of a resource (e.g. to power down and stop using power). When the signal is high, the request is being made. When the signal is low, no request is being made.
PSTATE: The new state that is being demanded as part of the request. In practice, PSTATE might be made up from a number of binary signals (e.g. M signals can be used to express 2^{M} different states)
PACCEPT: A response from a usage device 120a as to whether the request received from the controller 110 is accepted or not. When the signal is high, the request is accepted. When it is low, the request has not been accepted (but may not have been refused either).
PDENY: A response from a usage device 120 as to whether the request received from the controller 110 is refused or not. When the signal is high, the request is refused. When it is low, the request has not been refused (but may not have been accepted either).
PDENYHINT: A signal to indicate whether a hint is being made that a refusal of the previously issued request is preferred (but not mandatory).

The restrictions on the assertions/deassertions can be summarised as follows:
PREQ can only transition from low to high when at least the following conditions are met:
   PDENYHINT is low and
   PACCEPTn is low and
   PDENY is low
PREQ can only transition from high to low when at least the following conditions are met:
   PDENYHINT is low and
   ((PACCEPT is high and PDENY is low) or (PACCEPT is low and PDENY is high))
PACCEPT can only transition from low to high when at least the following conditions are met:
   PREQ is high and
   PDENY is low
PACCEPT can only transition from high to low when at least the following conditions are met:
   PREQ is low
PDENY can only transition from low to high when at least the following conditions are met:
   PREQ is high and
   PACCEPT is low
PDENY can only transition from high to low when at least the following conditions are met:
   PREQ is low
PDENYHINT can only transition from low to high when at least the following conditions are met:
   PREQ is high and
   PACCEPT is low and
   PDENY is low
PDENYHINT can only transition from high to low when at least either of the following conditions are met:
   PREQ is high
   ((PACCEPT is high and PDENY is low) or (PACCEPT is low and PDENY is high)

Note that FIG. 5 refers to a state P{DENY, ACCEPT}, which refers to a pair of signals in which exclusively one of PACCEPT or PDENY can be asserted at a time. The PACCEPT/PDENY timing is the same, unlike QACCEPTn and QDENY.

In the example of FIG. 5, PREQ is asserted. In addition, the value of PSTATE (not shown) is set to the desired new state that the controller 110 would like the usage device 120a to adopt. In this example, the value of PDENYHINT is raised, indicating that the request should (if possible) be refused. The value of P{DENY, ACCEPT} is set to high, indicating that the request was accepted or refused. This results in PDENYHINT being de-asserted. The value of PREQ is then de-asserted and, in response, P{DENY, ACCEPT} is lowered.

FIG. 6 shows a flowchart 600 that illustrates an example of the decision making process for determining whether a hint should be followed. The process starts at a step 610 in which a hint is received. In this example, the system is able to operate in two different modes: a completion proportion mode in which a decision is made based on what proportion of the resource change has taken place and a resource cost mode in which a decision is made by comparing the cost of complying against the cost of reverting. If the mode is completion proportion then the process proceeds to step 630 where a proportion of resource usage that has changed (between the request being made and the hint being received) is determined. That is, the amount of the transition that has been performed so far is considered. At step 640, if that proportion is below some threshold, then at step 650, the request is refused. Otherwise at step 690 the request is accepted. Thus, in this mode, if the amount of the transition is below a threshold (as measured by an amount of the resource usage—or in other embodiments an amount of time, or a number of operations to be performed) then the transition is stopped.

In an alternative mode (the resource cost mode), at step 660, the cost of complying with the original request is calculated. Then, at step 670, the cost of reverting the request is calculated. These costs could be in terms of the resource or could be in terms of all resources. This information can be determined from previous experience of the system, or can be hard-coded (e.g. by a designer using theoretical values). In any event, if the cost of reverting is smaller then at step 690 the original request is accepted (that is, the hint is ignored) otherwise at step 650, the original request is refused (the hint is followed). Consequently, if it is cheaper to revert then the original request is followed. The hint is therefore ignored, (keeping in mind that a reversion is likely to follow). Otherwise, the original request is refused and the hint is followed (since no reversion will follow).

Other techniques will be known to the skilled person.

FIG. 7 shows a pair of flow charts 700, 730 that illustrate the processes performed by the control apparatus 110 and the usage devices 120a, 120b, 120c. At a step 710, a request to change the usage of the usage devices 120a, 120b, 120c is asserted by the control apparatus 110. A hint is then asserted at step 720 that the request should be refused (if possible). The hint is issued to those of the usage devices 120a, 120b, 120c that have not responded (and therefore one or more responses might occur after the assertion of the request and before assertion of the hint). At a step 740, the request to change usage is received by the usage devices 120a, 120b, 120c. Then, at step 750 the hint (which was transmitted by the control apparatus 110 in step 720) is received. The request and/or the hint are then used by the usage devices 120a, 120b, 120c to determine how the request should be responded to at step 760.

The above examples have concentrated primarily on a resource in the form of energy. However, the usage of other resources can be controlled using the same mechanism. For instance, the resource might be a bridge between different domains, the usage of a particular circuit, or indeed other situations in which preparation is made in order to enable or disable the resource usage.

As a consequence of the above, it is possible to limit the negative effects associated with requests being complied with and then reversed.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A control apparatus comprising:
assertion circuitry configured to assert a request for a plurality of usage devices to change their usage of a resource from an original usage;
receive circuitry configured to receive a response to the request from the plurality of usage devices; and
hint circuitry configured to assert a hint to those of the plurality of usage devices for which the response has not been received, that a refusal in response to the request is preferred over an acceptance.

2. The apparatus according to claim 1, wherein
the hint is asserted in response to a refusal from one of the plurality of usage devices.

3. The apparatus according to any preceding claim, wherein
the resource is energy.

4. The apparatus according to claim 1, wherein
the request is for the plurality of usage devices to change an energy level at which the plurality of usage devices operate.

5. The apparatus according to claim 1, wherein
the request is for the plurality of usage devices to lower their usage of the resource.

6. The apparatus according to claim 1, wherein
the assertion circuitry is configured, in response to the response being received from each of the plurality of usage devices when the response from one of the usage devices is a refusal, to assert a further request for a second of the plurality of usage devices to return to the original usage.

7. The apparatus according to claim 1, wherein
the request is asserted using P-Channels or Q-Channels.

8. A method comprising:
asserting a request for a plurality of usage devices to change their usage of a resource from an original usage; and
asserting a hint to those of the plurality of usage devices for which a response to the request has not been received, that a refusal in response to the request is preferred over an acceptance.

9. A usage device comprising:
receive circuitry configured to receive, from a control apparatus, a request to change the usage device's usage of a resource from an original usage, and to receive, from the control apparatus, a hint that a refusal in response to the request is optional and preferred;
determination circuitry configured to make a determination of whether the request is to be met based on at least one of: the request and the hint; and
response circuitry configured to provide a response to the request based on the determination.

10. The usage device according to claim 9, wherein the resource is energy.

11. The usage device according to claim 9, wherein
the request is for the usage device to change an energy level at which the usage device operates.

12. The usage device according to claim 9, wherein the request is for the usage device to lower its usage of the resource.

13. The usage device according to claim 9, wherein
the request is asserted using P-Channels or Q-Channels.

14. The usage device according to claim 9, wherein
the determination circuitry is configured to make the determination based on a proportion of the usage device's usage of the resource that has changed between the request and the hint being received by the receive circuitry.

15. The usage device according to claim 9, wherein
the determination circuitry is configured to make the determination based on an estimated cost difference between:
a cost of complying with the request between the request and the hint being received by the receive circuitry; and
a cost of reverting to the original usage after the request has been complied with.

16. A method comprising:
receiving a request from a control apparatus to change the usage device's usage of a resource from an original usage;
receiving a hint from the control apparatus that a refusal in response to the request is optional and preferred;
making a determination of whether the request is to be met based on at least one of: the request and the hint; and
providing a response to the request based on the determination.
